(19) United States
(12) Patent Application Publication
(10) Pub. No.: US 2024/0330400 A1
(43) Pub. Date: Oct. 3, 2024

(54) AUTOMATED CORRELATION ANALYSIS AND SELF-REGULATION OF ATTRIBUTES

(71) Applicant: Oracle International Corporation, Redwood Shores, CA (US)

(72) Inventors: Shrinidhi Mahishi, Dharward (IN); Suresh Kumar Golconda, Fremont, CA (US); Vidya Mani, Bengaluru (IN); Karthik Venkata Dharani Gontla, Bangalore (IN); Neelesh Shukla, Redwood Shores, CA (US); Amit Vaid, Bengaluru (IN)

(73) Assignee: Oracle International Corporation, Redwood Shores, CA (US)

(21) Appl. No.: 18/313,260

(22) Filed: May 5, 2023

Related U.S. Application Data
(60) Provisional application No. 63/493,692, filed on Mar. 31, 2023.

(51) Int. Cl. G06F 17/15; G06F 17/18

(52) U.S. Cl. CPC G06F 17/15; G06F 17/18

(57) ABSTRACT

Operations associated with determining correlations between various attributes are disclosed. The operations may include: identifying a target attribute and a plurality of influencing attributes, determining a first correlation value representing a first correlation between the target attribute and a first influencing attribute of the plurality of influencing attributes, determining a second correlation value representing a second correlation between the target attribute and a second influencing attribute of the plurality of attributes, and based on the first correlation value and the second correlation value, ranking the first influencing attribute higher than the second influencing attribute in a ranked list of the plurality of influencing attributes representing an influence of each of the plurality of influencing attributes on the target attribute.

### INCORPORATION BY REFERENCE; DISCLAIMER

The following application is hereby incorporated by reference: application No. 63/493,692, filed Mar. 31, 2023. The applicant hereby rescinds any disclaimer of claims scope in the parent application(s) or the prosecution history thereof and advise the USPTO that the claims in the application may be broader than any claim in the parent application(s).

### TECHNICAL FIELD

The present disclosure relates to including using correlation models to determine correlations between various attributes associated with an asset.

### BACKGROUND

The performance of an asset may depend on numerous interrelated attributes. In some instances, the extent to which an attribute influences other attributes of the asset may not be readily apparent. For example, the influence of an attribute may be obscured by other influencing attributes. With increasing asset connectivity, including increasing presence of sensors, processing ability, software, and other technologies, data associated with various assets and their respective attributes may be increasingly available.

The content of this background section should not be construed as prior art merely by virtue of its presences in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations in accordance with one or more embodiments;

FIG. 3A illustrates an example asset management system in accordance with one or more embodiments;

FIG. 3B illustrates an example dataset in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. INTRODUCTION
2. GENERAL OVERVIEW
3. CORRELATION MANAGEMENT SYSTEM
4. CORRELATION-BASED AUTOMATED ATTRIBUTE CONFIGURATION
5. CORRELATION-BASED ASSET MANAGEMENT
6. PRACTICAL APPLICATIONS, ADVANTAGES & IMPROVEMENTS
7. HARDWARE OVERVIEW
8. COMPUTER NETWORKS AND CLOUD NETWORKS
9. MISCELLANEOUS; EXTENSIONS

### 1. Introduction

An asset, as referred to herein, includes any software and/or hardware system, with one or more components, that is associated with a set of attributes. By way of example, an asset may include a machine, such as a computing system, a vehicle, or a manufacturing apparatus. An attribute of the asset may include, for example, a pressure, a temperature, a vibration, a performance metric, a speed, an efficiency, or an operational quality. The values for the attribute may be detected (e.g., via sensors) or computed via a function. The dataset or values corresponding to an attribute may be of a continuous data type or a categorical data type. A continuous data type refers to measurable data such as pressure, temperature, vibration, and speed. A dataset of a continuous data type may have an infinite number of possible values. A dataset of a continuous data type typically includes numerical values. A categorical data type refers to data with a finite set of possible values. A categorical data type may have numerical values, alphabetic values, or alphanumerical values. The values in a dataset of a categorical data type with alphabetic values may be, for example, one of high, medium, or low. The values in a dataset of a categorical data type with numerical values may be, for example, an integer between 0 and 10. One or more of a set of asset attributes may influence other attribute(s) of the set of asset attributes. The extent to which an attribute (referred to herein as an “influencing attribute”) influences another attribute (referred to herein as a “target attribute”) may not be readily apparent.

### 2. Overview

One or more embodiments apply different correlation models to determine correlation/influence between different pairs of asset attributes. Each of n pairs of the asset attributes includes (a) the same target attribute and (b) one of a set of n influencing attributes whose influence on the target attribute is to be determined. For each pair of attributes, the system selects one or more correlation models, for determining the correlation between that pair of attributes, based on a data-type combination. The data-type combination includes a first data-type corresponding to the target attribute and a second data-type corresponding to the influencing attribute in the pair of attributes. The system executes each of the one or more correlation models to compute candidate correlation values that represent the correlation between the pair of attributes. The system selects one of the candidate correlation values (e.g., the candidate correlation value representing a highest correlation) as the correlation value to represent the correlation between the pair of attributes. The correlation value further represents an influence of (a) the influencing attribute in the pair of attributes on (b) the target attribute in the pair of attributes.

Based on the correlation value determined for representing an influence of each influencing attribute on the target attribute, the system selects one or more of the influencing attributes for configuration. The system may select, for example, influencing attributes with a threshold level of influence on the target attribute, or the m highest-influencing attributes of the set of influencing attributes. Configuring the influencing attributes may include, for example, determining and maintaining preferred values for the influencing attributes that correspond to the preferred values for the target attribute.

This General Overview section is intended to provide a general overview without addressing all aspects of the present disclosure. The full scope of the presently disclosed subject matter is understood from the content of the present disclosure in its entirety.

### 3. Correlation Management System

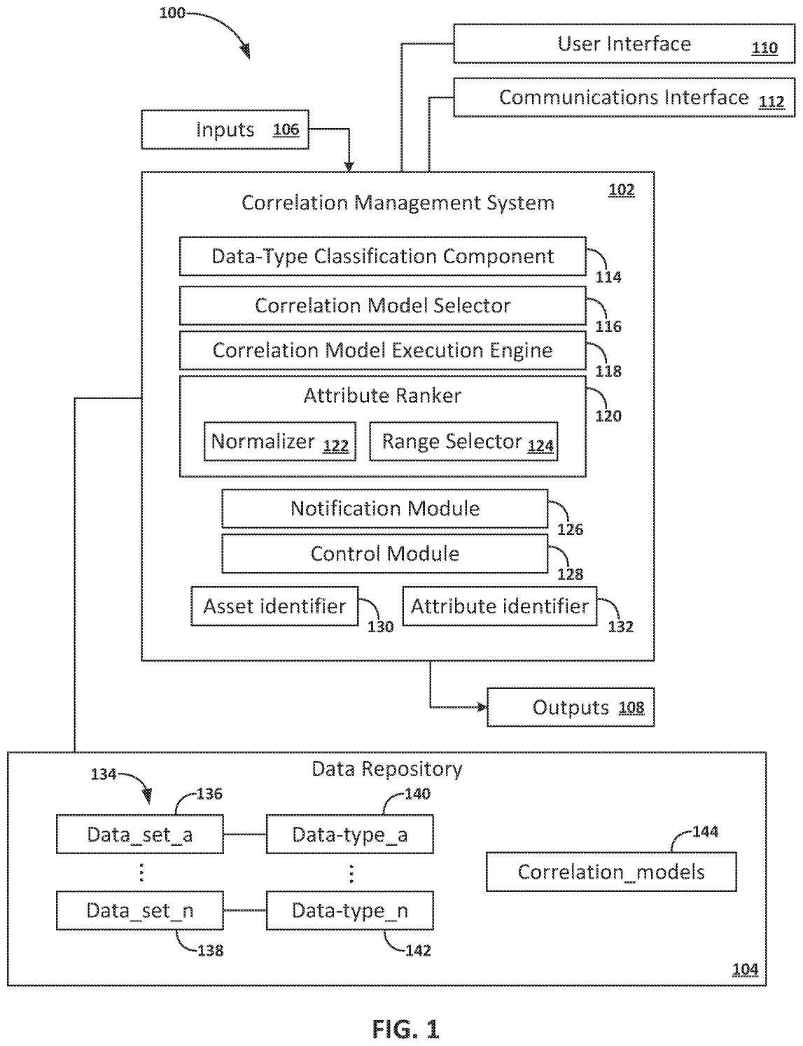

Referring now to FIG. 1, the presently disclosed subject matter is further described. As shown in FIG. 1, a system 100 in accordance with one or more embodiments may be associated with one or more assets. The system 100 may be utilized to perform operations in accordance with the present disclosure, including to determine correlations between a set of attributes, such as a set of influencing attributes and at least one target attribute, and/or to perform operations based at least in part on determined correlations.

In at least one example, an influencing attribute and/or a target attribute may include an intensive property, such as at least one of: an acoustic property; an atomic property; a chemical property; an electrical property; a magnetic property; a materials property; a manufacturing property; a mechanical property; an optical property; a radiological property; or a thermal property. By way of example, an intensive property may include at least one of: charge density; chemical potential; color; concentration; energy density; magnetic permeability; mass density (or specific gravity); melting point; boiling point; molality; pressure; vibration; refractive index; specific conductance (or electrical conductivity); specific heat capacity; specific internal energy; specific rotation; specific volume; standard reduction potential; surface tension; temperature; thermal conductivity; velocity; or viscosity. Additionally, or in the alternative, an influencing attribute may include an extensive property, such as: amount at least one of; amount of a substance; enthalpy; entropy; Gibbs energy; heat capacity; Helmholtz energy; internal energy; spring stiffness; mass; or volume.

An influencing attribute and/or a target attribute may include a conjugate quantity (e.g., a transfer of an extensive quantity are associated with a change in a specific intensive quantity), a composite property (e.g., a mathematical combination of two or more influencing attributes), or a specific property (e.g., an intensive property obtained by subject an extensive property of a system to a mathematical operator). An influencing attribute may be a constant or may be a function of one or more independent data, such as one or more other influencing attributes or other physical phenomena.

The system 100 may include a correlation management system 102 and a data repository 104 communicatively coupled or couplable with one another. The correlation management system 102 may include hardware and/or software configured to carry out various operations in accordance with the present disclosure. The data repository 104 may include data utilized and/or stored by the correlation management system 102 in association with carrying out various operations.

The correlation management system 102 may receive inputs 106 from various sources and may provide outputs 108 to various sources. For example, various assets may provide inputs 106 to the correlation management system 102, such as data from sensors, controllers, and/or computing devices associated with a respective asset. Additionally, or in the alternative, the inputs 106 may include data from the data repository 104 and/or from other sources. The outputs 108 from the correlation management system 102 may include data for various assets, such as for sensors, controllers, and/or computing devices associated with a respective asset. Additionally, or in the alternative, the outputs 108 may include data to the data repository 104 and/or to other sources.

The system 100 may include a user interface 110 communicatively coupled or couplable with the correlation management system 102 and/or the data repository 104. The user interface may include hardware and/or software configured to facilitate interactions between a user and the correlation management system 102.

The system 100 may include a communications interface 112 communicatively coupled or couplable with the correlation management system 102 and/or the data repository 104. The communications interface 112 may include hardware and/or software configured to transmit data to and/or from the system 100, and or between respective components of the system 100. For example, the communications interface 112 may transmit and/or receive data between and/or among the correlation management system 102, the data repository 104, the user interface 110, including transmitting and/or receiving inputs 106 and/or outputs 108.

As shown in FIG. 1, the correlation management system 102 may include a data-type classification component 114. The data-type classification component 114 includes a software and/or hardware component with functionality to determine and/or classify a data-type of various attributes, including a data-type of various influencing attributes and/or a data-type of target attributes. Additionally, or in the alternative, the data-type classification component 114 may determine and/or classify a data-type combination for various attribute combinations, such as combinations of an influencing attribute and a target attribute.

The correlation management system 102 may include a correlation model selector 116. The correlation model selector 116 includes a software and/or hardware component(s) with functionality to map various data-type combinations to a corresponding set of one or more correlation models to be used for the data-type combination. The mapping of various data-type combinations to a corresponding set of one or more correlation models may be stored in the data repository 104 for future reference, for example, when executing a correlation model with respect to a dataset corresponding to a selected combination of attributes. Additionally, or in the alternative, the correlation model selector 116 may select a set of one or more correlation models to be used for a respective data-type combination. For example, the correlation model selector 116 may determine a set of one or more correlation models to be executed for a respective dataset based on the data-type combination determined by the data-type classification component 114 and/or based on the mapping of the data-type combination to the set of correlation models, as stored in the data repository 104. In at least one example, various correlation models may be added or removed to a set corresponding to a respective data-type combination, for example, by the correlation model selector 116.

The correlation management system 102 may include a correlation model execution engine 118. The correlation model execution engine 118 includes a software and/or hardware component(s) with functionality to execute a set of one or more correlation models with respect to a dataset corresponding to a selected combination of attributes. The dataset may include data representing the respective attributes in an operationalized way for data processing. The respective data may include values that vary across an operational domain for the data. For a respective combination of attributes, such as an influencing attribute and a target attribute, the correlation model execution engine 118 may apply the set of correlation models to the data values for the target attribute and the respective influencing attribute to compute a set of one or more candidate correlation values that represent a correlation between the target attribute and the respective influencing attribute. Additionally, or in the alternative, the correlation model execution engine 118 may select a correlation value from the set of candidate correlation values to represent the correlation between the target attribute and the respective influencing attribute. The correlation value selected by the correlation model execution engine 118 may be the candidate correlation value corresponding to the correlation with the lowest degree of observational error. Additionally, or in the alternative, the correlation value selected by the correlation model execution engine 118 may be the candidate correlation value representing the highest correlation from among the candidate correlation values. The correlation model execution engine 118 may repeat its operations for respective correlation models, for example, concurrently or sequentially.

The correlation management system 102 may include an attribute ranker 120. The attribute ranker 120 includes a software and/or hardware component(s) with functionality to rank a set of influencing attributes based on their respective correlation values representing the correlation between the respective influencing attributes and the target attribute. The attribute ranker 120 may provide a ranked list that includes a set of influencing attributes and their respective ranking. The ranking of the respective influencing attributes may represent an influence of the respective influencing attributes on the target attribute.

In at least one example, the attribute ranker 120 may include a normalizer 122 and/or a range selector 124. The normalizer 122 may normalize the selected correlation values, for example, to provide a normalized basis for comparison and ranking of correlation values corresponding to respective influencing attributes. The attribute ranker 120 may rank the set of influencing attributes based on their respective normalized correlation values, for example, after having been normalized by the normalizer 122. The range selector 124 may determine a preferred range of values for one or more of the respective attributes.

The normalizer 122 may determine normalized correlation values by applying a scaling function to correlation values. The normalizer 122 may utilize a particular scaling function that corresponds to the correlation model used to provide the correlation value. The scaling function used to normalize correlation values may depend at least in part on the range of values for a correlation value resulting from the respective correlation model. Correlation values may be taken as normalized correlation values when comparing among correlation models that have the same or similar range. Additionally, or in the alternative, correlation values from respective correlation models that have the same or similar range may be subjected to the same scaling function. In at least one example, a first one or more correlation values that include or are based on a first correlation model may provide a basis for normalization, and a second one or more correlation values may be normalized on the basis for normalization provided by the first correlation model.

By way of example, a correlation model that includes or is based on at least one of a Pearson correlation model, a Spearman correlation model, a Kendall tau correlation model, or a Cramer's V Test correlation model may provide a basis for normalization. Correlation values resulting from these correlation models may be converted to absolute values, and then may be taken as normalized correlation values and/or may be compared with one another with or without modification. For example, correlation value ranges for these correlation models may be as follows: Pearson: −1 to 1; Spearman: −1 to 1; Kendall tau: −1 to 1; or Cramer's V Test: 0 to 1. A scaling function for a correlation model that includes or is based on at least one of a Pearson correlation model, a Spearman correlation model, a Kendall tau correlation model, or a Cramer's V Test correlation model may be normalized according to a scaling function that includes the following relationship: nCV=abs(CV), where abs(CV) is the absolute value of the correlation value and nCV is the normalized correlation value. Normalized ranges may be as follows: Pearson: 0 to 1; Spearman: 0 to 1; Kendall tau: 0 to 1; or Cramer's V Test: 0 to 1.

Additionally, or in the alternative, for a correlation model that includes or is based on at least one of an ANOVA correlation model, a Chi-Square correlation model, or a T-test correlation model, the correlation values may have a range of from 0 to 1030. A scaling function for a correlation model that includes or is based on at least one of an ANOVA correlation model, a Chi-Square correlation model, or a T-test correlation model may be normalized according to the following relationship: nCV=CV/(25+CV), where CV is the correlation value and nCV is the normalized correlation value. The normalized correlation values corresponding to a correlation model that includes or is based on an ANOVA correlation model, a Chi-Square correlation model, or a T-test correlation model may be compared on a normalized basis, including with respect to one another and/or with respect to correlation values corresponding to a correlation model that includes or is based on a Pearson correlation model, a Spearman correlation model, a Kendall tau correlation model, or a Cramer's V Test correlation model.

As another example, for a correlation model that includes or is based on at least one of mutual_info_regression or mutual_info_classification, the correlation values may have a range of from 0 to 2.2. A scaling function for a correlation model that includes or is based on at least one of mutual_info_regression or mutual_info_classification may be normalized according to the following relationship: nCV=CV/(0.2+CV), where CV is the correlation value and nCV is the normalized correlation value. The normalized correlation values corresponding to a correlation model that includes or is based on mutual_info_regression or mutual_info_classification may be compared on a normalized basis, including with respect to one another and/or with respect to normalized correlation values corresponding to a correlation model that includes or is based on a Pearson correlation model, a Spearman correlation model, a Kendall tau correlation model, or a Cramer's V Test correlation model, and/or that includes or is based on an ANOVA correlation model, a Chi-Square correlation model, or a T-test correlation model.

The preferred range of values may be determined based on the ranked list of the set of influencing attributes. The range selector 124 may determine the preferred range of values for respective influencing attributes by determining a preferred range of values for the target attribute, determining at least one candidate range of values for the respective influencing attribute that are mapped to the preferred range of values for the target attribute, and selecting from among the candidate range of values, a range of values for the influencing attribute as the preferred range of values for the influencing attribute.

The range selector 124 may determine the preferred range of values for all or a portion of the influencing attributes in the ranked list. For example, a preferred range of values may be determined for influencing attributes that meet a threshold level of influence on the target attribute. The range selector 124 may bypass influencing attributes that are relatively lower on the ranked list, such as influencing attributes that do not meet the threshold level of influence on the target attribute. The threshold level of influence may be selected at least in part to facilitate a determination, for example, by the range selector 124, as to whether respective influencing factors are sufficiently influential to configure a preferred range of values. In at least one example, the range selector 124 may determine a preferred range of values for a first influencing attribute without determining a preferred range of values for a second influencing attribute, for example, when the first influencing attribute is more influential on the target attribute than the second influencing attribute. The first influencing attribute may exceed the threshold for the range selector to configure the preferred range of values. The second influencing attribute may be below the threshold and, as such, the range selector 124 would not configure a preferred range of values for the second influencing attribute.

Referring further to FIG. 1, the correlation management system 102 may include a notification module 126. The notification module 126 may configure a notification to be triggered when a current value for an influencing attribute does not match a preferred range of values for the influencing attribute. Additionally, or in the alternative, the notification module 126 may monitor current values for one or more influencing attributes against their respective preferred range of values, and/or the notification module 126 may trigger the notification upon determining that a current value for an influencing attribute does not match the corresponding preferred range of values.

The correlation management system 102 may include a control module 128. The control module 128 includes a software and/or hardware component(s) with functionality to configure one or more system components associated with a respective asset to maintain at least one influencing attribute within a preferred range of values for the respective influencing attribute. Additionally, or in the alternative, the control module 128 may dispatch control commands to the one or more system components responsive to a current value for a respective influencing attribute, for example, to maintain the respective influencing attribute within the preferred range of values.

The correlation management system 102 may include an asset identifier 130. The asset identifier 130 may automatically identify assets associated with the control management system 102, for example, when assets are added or removed from the system 100, and/or when a status of a respective asset changes. For example, the asset identifier 130 may determine a status change, such as when assets are introduced into service, removed from service, placed into an active status, placed into an idle or inactive status, and so forth. Various operations of the correlation management system 102 may be executed responsive to an asset and/or an asset status having been determined by the asset identifier 130.

The correlation management system 102 may include an attribute identifier 132. The attribute identifier 132 may automatically identify attributes associated with the control management system 102 and/or a respective asset. Additionally, or in the alternative, the attribute identifier 132 may determine one or more properties of an attribute, such as a data type associated with the attribute and/or whether the attribute may be an influencing attribute or a target attribute. In at least one example, the attribute identifier 132 may automatically identify attributes and/or one or more properties of respective attributes, when assets are added or removed from the system 100, and/or when a status of a respective asset changes. Various operations of the correlation management system 102 may be executed responsive to an attribute and/or one or more properties of the attribute having been determined by the attribute identifier 132.

Referring further to FIG. 1, the data repository 104 may include a set of datasets 134 associated with the correlation management system 102 and/or respective assets, and/or attributes. The data repository 104 may include a dataset 134 for each of a set of attributes associated with the correlation management system 102. For example, the data repository 104 may include a set of particular datasets 134 with each particular dataset 134 respectively corresponding to a respective one of the set of attributes. The data repository 104 may include a particular dataset 134 for each of a set of influencing attributes and for at least one target attribute. The dataset 134 may additionally include an identification of the data type for the respective attributes.

The type of data may include qualitative data (also referred to herein as categorical data) or quantitative data. For example, the data-type classification component 114 may classify a data-type for an attribute as either being a qualitative data-type or a quantitative data-type. By way of example, a qualitative data may be a Boolean data, an ordinal data, or a nominal data.

The terms “qualitative data” and “qualitative data-type” or the terms “categorical data” and “categorical data-type” respectively refer to a data that can take on one of a limited number of possible values, such as a fixed number of possible values. An attribute that has a qualitative data-type may be assigned to a particular group or nominal category based on some qualitative property. The terms “quantitative data” and “quantitative data-type” refer to a data that can take on an infinite or non-infinite number of values, for example, that may be obtained by measuring or counting.

A qualitative data may be a dichotomous data (also called a binary data) or a polytomous data. A qualitative data-type may include a dichotomous data-type or a polytomous data. The terms “dichotomous data” and “dichotomous data-type” refer to a qualitative data that can take on exactly two values. The terms “polytomous data” and “polytomous data-type” refer to a qualitative data with more than two possible values.

A quantitative data may be a continuous data or a discrete data. A qualitative data-type may include a continuous data-type or a discrete data. By way of example, a quantitative data may be an integer data or a floating-point data. The terms “continuous data” and “continuous data-type” refer to a quantitative data for which a value may be obtained by measuring. For example, a continuous data may be capable of exhibiting an uncountable set of values. The terms “discrete data” and “discrete data-type” refer to a quantitative data for which there exists a one-to-one correspondence between the data and a set of natural numbers (e.g., 0, 1, 2, 3 . . . n, etc.) spanning a particular interval of finite or countably infinite values.

The data-type combination for a combination of attributes refers to the data-type of the respective attributes. The data-type combination may include a notation represented by the respective data-types with a colon between them. For example, a data-type combination for a first attribute that has a first data-type and a second attribute that has a second data-type may be represented by the notation: first-data-type:second-data-type. Additionally, or in the alternative, a data-type combination for an influencing attribute and a target attribute may be represented by the notation: influencing-attribute-data-type:target-attribute-data-type.

The data-type combination may include one or more of the following: quantitative:quantitative; quantitative:qualitative; qualitative:qualitative; qualitative:quantitative. Additionally, or in the alternative, the data-type combination may include one or more of the following: quantitative-continuous:quantitative-continuous; quantitative-continuous:quantitative-discrete; quantitative-discrete:quantitative-discrete; quantitative-discrete:quantitative-continuous; quantitative-continuous:qualitative-dichotomous; quantitative-continuous:qualitative-polytomous; quantitative-discrete:qualitative-dichotomous; quantitative-discrete:qualitative-polytomous; qualitative-dichotomous:qualitative-dichotomous; qualitative-dichotomous:qualitative-polytomous; qualitative-polytomous:qualitative-polytomous; qualitative-polytomous:qualitative-dichotomous; qualitative-dichotomous:quantitative-continuous; qualitative-dichotomous:quantitative-discrete; qualitative-polytomous:quantitative-continuous; or qualitative-polytomous:quantitative-discrete.

A respective dataset 134 may include a data representing the respective attribute in an operationalized way for data processing, and a set of values corresponding to the data that vary across an operational domain for the data. The respective dataset 134 may additionally include a data type mapped to the data corresponding to the respective attribute. The data and/or the values in the respective dataset 134 may have a 1:1 mapping relationship with the data type. In at least one embodiment, the data-type classification component may determine the data type associated with a respective asset based at least in part on the 1:1 mapping relationship between the data type and the data and/or the values in the respective dataset 134.

By way of example, as shown in FIG. 1, the data repository 104 may include a first dataset 136 corresponding to a first attribute and a second dataset 138 corresponding to a second attribute. In one process execution, the first attribute may be selected as an influencing attribute. The second attribute may be selected as a target attribute. In another process execution, the first attribute may be selected as the target attribute and other attributes may be selected as the influencing attributes. As would be understood by a person of ordinary skill in the art, a user may select any of the attributes as a target attribute or as influencing attributes for the system to perform the embodiments as described herein.

The first dataset 136 may be mapped with a 1:1 relationship to a first data type 140 that corresponds to the first attribute. The second dataset 138 may be mapped with a 1:1 relationship to a second data type 142 that corresponds to the second attribute. The first dataset 136 may include a first data representing the first attribute, such as the influencing attribute, in an operationalized way for data processing, and a first set of values corresponding to the first data that vary across an operational domain for the first data. The first data and/or the first set of values may be mapped with a 1:1 relationship to the first data type 140. The second dataset 138 may include a second data representing the second attribute, such as the target attribute, in an operationalized way for data processing, and a second set of values corresponding to the second data that vary across an operational domain for the second data. The second data and/or the second set of values may be mapped with a 1:1 relationship to the second data type 140.

In at least one example, the data repository may include a set of correlation models 144. Respective correlation models may be mapped to respective data-types and/or respective data-type combinations. The data-type classification component 114 may determine a data-type corresponding to a respective attribute and/or a data-type combination corresponding to a respective attribute combination based at least in part on the mapped relationship between the datasets 136 and corresponding data types in the data repository 104. The correlation model selector 116 may determine a set of correlation models 114 to be executed by the correlation model execution engine 118 based at least in part on a mapped relationship between the correlation models and corresponding data-types and/or data-type combinations for which respective correlation models may be utilized.

A correlation model may provide a correlation that exhibits a linear or non-linear relationship. Additionally, or in the alternative, the relationship may be parametric or non-parametric. The correlation may span a range that differs as between respective correlation models.

Example correlation models may include: a Pearson correlation model, Spearman correlation model, a mutual_info_regression correlation model, a mutual_info_classification correlation model, a Kendall tau correlation model, an ANOVA correlation model, a T-Test correlation model, a Chi-Square correlation model, or a Cramer's V Test correlation model, as well as combinations of these.

In at least one example, a Pearson correlation model may measure the strength and direction of linear relationships between pairs of continuous data.

In at least one example, a Spearman correlation model may measure the strength and direction of non-linear relationships between pairs of continuous data.

In at least one example, a mutual_info_regression correlation model may estimate mutual information for a continuous target data. For a mutual_info_regression correlation model, a correlation value is a non-negative value that measures the dependency between the data. The correlation value may be equal to zero if and only if two random data are independent, and higher correlation values mean higher dependency.

In at least one example, a mutual_info_classification correlation model may estimate mutual information for a discrete target data. For a mutual_info_classification correlation model, a correlation value is a non-negative value that measures the dependency between the data. The correlation value may be equal to zero if and only if two random data are independent, and higher values mean higher dependency.

In at least one example, a Kendall tau correlation model may be configured as a statistic used to measure an ordinal association between two measured quantities. A Kendall tau correlation model may include a non-parametric hypothesis test for statistical dependence based on the Tau (τ) coefficient.

In at least one example, an ANOVA correlation model may compare the means of two or more independent groups to determine whether there is statistical evidence that the associated population means are significantly different.

In at least one example, a T-Test correlation model may compare a sample mean to a hypothesized value for a population mean to determine whether the two means are significantly different.

In at least one example, a Chi-Square correlation model may determine whether there is an association between categorical data (i.e., whether the data are independent or related). A Chi-Square correlation model may include a nonparametric test.

In at least one example, a Cramer's V Test correlation model may measure the strength of association between two nominal data. A Cramer's V Test correlation model may include a nonparametric statistic used in cross-tabulated table data.

### 3. Correlation-Based Automated Attribute Configuration

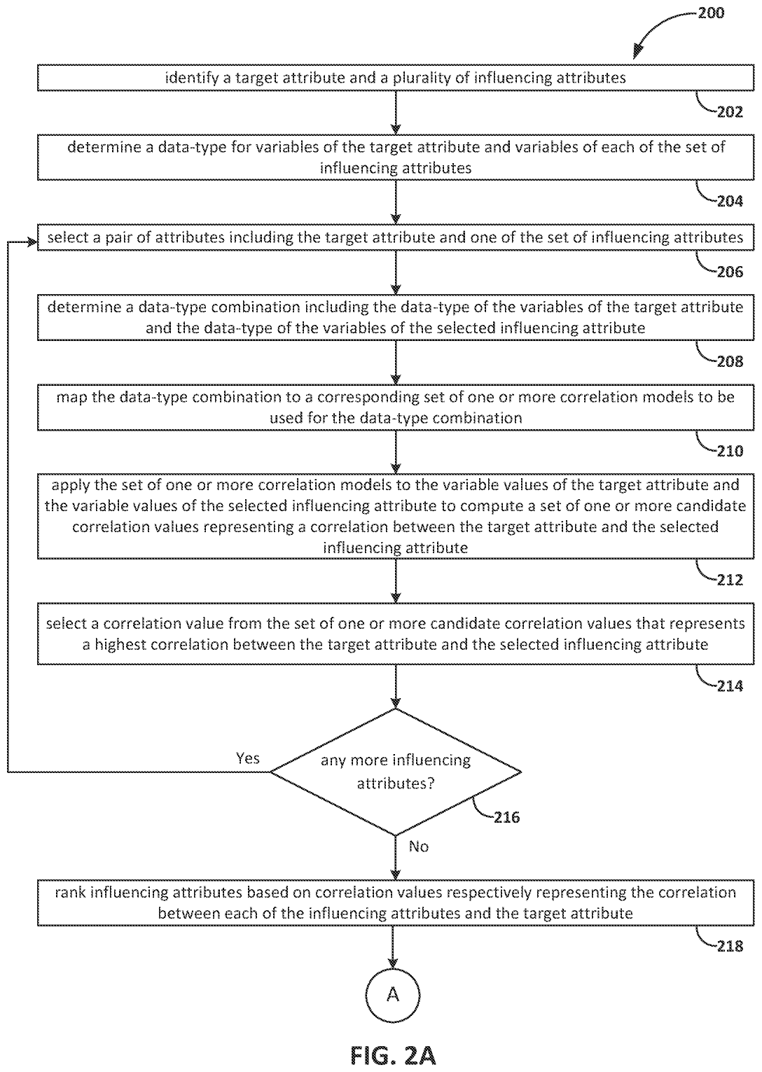

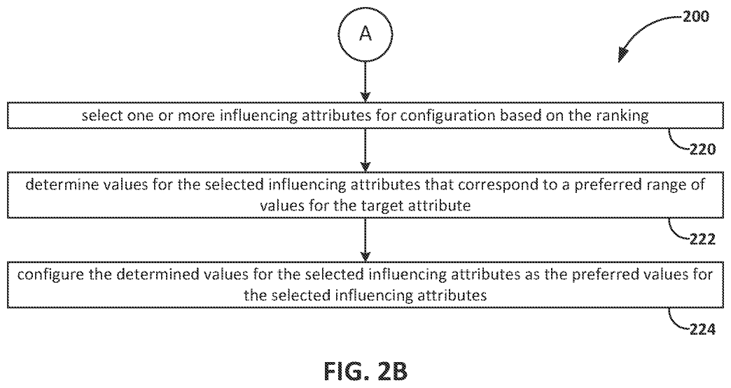

Referring now to FIGS. 2A and 2B, the presently disclosed subject matter is further described. The presently disclosed system 100 may perform operations 200. The operations 200 may be associated with the correlation management system 102. Various components of the system 100 may be utilized to perform the operations 200. The operations 200 may include determining correlations between a set of attributes, such as a set of influencing attributes and at least one target attribute, and/or performing operations based at least in part on determined correlations. The operations 200, such as those described with reference to FIGS. 2A and 2B. may be performed sequentially or concurrently for a set of target attributes associated with an asset, and/or for a set of assets and their respective target attributes. For a respective target attribute and/or a respective asset, the operations 200, such as those described with reference to FIGS. 2A and 2B, may be performed sequentially or concurrently for a set of influencing attributes corresponding to the respective target attribute or asset.

As shown in FIG. 2A, the operations 200 may include, at block 202, identifying a target attribute and a set of influencing attributes. The system 100 may identify the target attribute and the system attribute using the attribute identifier 132 of the correlation management system 102. In at least one example, the system 100 may identify the target attribute and a set of influencing attributes based on inputs 106 to the correlation management system 102. The inputs 106 may include data from sensors, controllers, and/or computing devices associated with a respective asset.

The system 100 may identify the target attribute and the set of influencing attributes based on user input that selects and classifies a subset of available attributes. The user input may select a particular attribute as the target attribute. The user input may further select other attributes as the influencing attributes.

The system 100 may identify the target attribute based on the use, priority, and access associated with the target attribute. In an example, the system 100 may monitor a user interface to determine that values for a particular attribute are most reviewed by users. The frequency of review may indicate that the particular attribute is a high priority attribute. The system 100 selects the particular attribute as the target attribute based on the frequency of review. In another example, the system 100 may determine that a component temperature exceeding a threshold value often results in overall system failure. In order to avoid the component temperature exceeding the threshold value and avoid overall system failure, the component temperature is selected as the target attribute. Other attributes are selected as influencing attributes so they can be analyzed and later configured to help maintain the target attribute within a preferred range of values. In at least one example, the system 100 may generate a list that identifies the plurality of influencing attributes selected at block 202.

At block 204, the operations 200 may include determining a data-type for variables of the target attribute and for variables of each of the set of influencing attributes. The system 100 may use the data-type classification component 114 of the correlation management system 102 to determine the data-type for data of the target attribute and data of each of the set of influencing attributes. In at least one example, the system 100 may inspect the data and determine the data type based on a format and/or a content of the data. For example, if the data consists of a range of numeric values, such as an infinite or non-infinite number of values, it is likely that the data type is a quantitative data-type. As another example, if the data consists of a finite group of ordered categories, it is likely that the data type is a qualitative data-type.

Additionally, or in the alternative, the system 100 may use pattern recognition to analyze patterns in the data and to determine the data type based on the patterns. Additionally, or in the alternative, the system 100 may use statistical analysis to analyze a distribution of the data to determine its data type. For example, if the data is distributed normally, it is likely that the data type is a continuous data type. Additionally, or in the alternative, the system 100 may use machine learning algorithms to learn patterns in the data and make predictions about its data type. For example, the system 100 can be trained on a set of labeled data to identify patterns and classify new data accordingly. Additionally, or in the alternative, the system 100 may use metadata to determine the data type. For example, if the attribute is labeled as a “temperature” in the metadata, it is likely that the data type is a quantitative data type. As another example, if the if the attribute is labeled as a “on/off state” in the metadata, it is likely that the data type is a qualitative data-type.

At block 206, the operations 200 may include selecting a pair of attributes including the target attribute and one of the set of influencing attributes. The system 100 may use the correlation model execution engine 118 of the correlation management system 102 to select the pair of attributes including the target attribute and one of the set of influencing attributes. The pair of attributes may be selected automatically by the system 100 and/or based on a user input.

In at least one example, the system 100 may rank the attributes based on some criteria, such as relevance or importance, and attributes may be selected based on ranking. Additionally, or in the alternative, the system 100 may use a machine learning model to predict which attributes are most relevant for a particular context and/or which attributes are predicted to provide information that is most useful, and attributes may be selected based on these predictions. Additionally, or in the alternative, the system 100 may analyze relationships between the attributes and one or more outcomes of interest, and attributes may be selected based on a strength of the correlation with a respective outcome. By way of example, an outcome of interest may include identifying attributes related to system failures, identifying attributes associated with system maintenance, identifying attributes assisted with a process change, or the like. Additionally, or in the alternative, the system 100 may analyze datasets to determine data quality parameters, such as completeness, accuracy, or consistency, and attributes may be selected based on such data quality parameters.

In addition, or in the alternative to the system 100 automatically selecting attributes, the system may allow a user to select attributes manually, for example, by displaying a list of available attributes and allowing the user to choose from the list. In at least one example, manual choices by a user may be combined with automatically selected attributes. The manual choices by a user may be supplemented by system rules for attribute selection. For example, the system 100 may abide by certain predefined rules that require selection of certain attributes and/or that require attributes to be selected that meet certain criteria.

At block 208, the operations 200 may include determining a data-type combination including the data-type of the variable of the target attribute and the data-type of the variable of the selected influencing attribute. The system 100 may use the data-type classification component 114 of the correlation management system 102 to determine the data-type combination. The system 100 may determine the data-type combination from the respective data type of the influencing attribute and the target attribute determined by the system at block 204.

At block 210, the operations 200 may include mapping the data-type combination to a corresponding set of one or more correlation models to be used for the data-type combination. The system 100 may use the correlation model selector 116 of the correlation management system 102 to map the data-type combination to the corresponding set of one or more correlation models to be used for the data-type combination. The mapping of various data-type combinations to a corresponding set of correlation models may be stored in the data repository 104 for reference, such as in a lookup table. The system 100 may reference the lookup table to map the data-type combination to the set of correlation models to be used.

By way of example, for a data-type combination that includes a first quantitative data-type and a second quantitative data-type, a correlation model set may include at least one of: a Pearson correlation model, a Spearman correlation model, or a mutual_info_regression correlation model.

As another example, for a data-type combination that includes a quantitative data-type and a qualitative data-type, and a correlation model set may include at least one of: a Kendall tau, an ANOVA correlation model, a T-Test correlation model, or a mutual_info_classification correlation model.

As another example, for a data-type combination that includes a first quantitative data-type and a second quantitative data-type, a correlation model set may include at least one of: a Chi-Square correlation model, a Cramer's V Test correlation model, or a mutual_info_classification correlation model.

At block 212, the operations 200 may include applying the set of one or more correlation models to the data values of the target attribute and the data values of the selected influencing attribute to compute a set of one or more candidate correlation values representing a correlation between the target attribute and the selected influencing attribute. The system 100 may use the correlation model execution engine 118 of the correlation management system 102 to apply the set of correlation models to the data values to compute the candidate correlation values. The system 100 may repeat the operations associated with applying a correlation model to the data values and computing a candidate correlation value for respective correlation models.

In at least on example, the system 100 may perform preprocessing operations the data values to prepare the data for use with the set of correlation models. The preprocessing operations may involve cleaning the data, transforming the data to a different format or scale, encoding categorical variables as numerical values, and the like. To apply a correlation model to the data values in the dataset and compute a set of candidate correlation values, the system 100 may load the correlation model into memory so that the correlation model can be applied to the dataset. This may involve loading the correlation model parameters, features, or other relevant data. Once the correlation model has been loaded into memory, the system 100 may apply various functions to the dataset to generate an output for each data value in the dataset. After the correlation model has generated the outputs, the system 100 may perform postprocessing operations, such as to analyze or visualize the outputs. The postprocessing operations may include calculating the candidate correlation value for the respective correlation model. calculating other summary statistics, generating plots or charts, or evaluating the performance of the correlation model on the dataset.

At block 214, the operations 200 may include selecting a correlation value from the set of one or more candidate correlation values that represents a highest correlation between the target attribute and the selected influencing attribute. The system 100 may use the attribute ranker 120 of the correlation management system 102 to select the correlation value that represents the highest correlation between the target attribute and the selected influencing attribute. In at least one example, the candidate correlation values may be normalized to provide a normalized basis for comparison between respective candidate correlation values.

To select a correlation value from the, the system 100 may utilize looping, sorting, recursion, or other built-in functions, as well as a combination of these. In at least one example, the system 100 may loop through the list of candidate correlation values and compare each candidate correlation value to a variable that is initially set to the first candidate correlation value in the list. If a candidate correlation value is found that is higher than the current maximum candidate correlation value, the variable is updated to match that candidate correlation value. Once the loop has finished, the variable will contain the highest candidate correlation value, and the system 100 can select the variable containing the highest candidate correlation value as the correlation value that represents the highest correlation between the target attribute and the selected influencing attribute.

Additionally, or in the alternative, the system 100 may utilize one or more built-in functions for finding the correlation value that represents the highest correlation between the target attribute and the selected influencing attribute, such as max( ) in Python or Math.max( ) in JavaScript. These functions may be configured to take the list of candidate correlation values as an input and return the highest value from the list.

In at least one example, the system 100 may sort the list of candidate correlation values, such as in descending order, and then the system 100 may select the first candidate correlation value from the sorted list as the correlation value that represents the highest correlation between the target attribute and the selected influencing attribute. Sorting may be less efficient than the other methods, especially for large lists.

In at least one example, the system 100 may use a recursive operation to find the highest candidate correlation value in the list. The recursive operation may include splitting the list into smaller sublists and recursively finding the highest value in each sublist until the entire list has been searched.

The operations 200 at block 202 through block 214 may be repeated for one or more influencing attributes from a set of influencing attributes, for example, with respect to a target attribute or asset corresponding to the set of influencing attributes. For example, the system 100 may determine a first correlation value for a first influencing attribute from a set of influencing attributes and a second correlation value for a second influencing attribute from the set of influencing attributes. The first correlation value may represent a first correlation between the target attribute and the first influencing attribute, and the second correlation value may represent a second correlation between the target attribute and the second influencing attribute.

At block 216, the operations 200 may include determining whether there are any more influencing attributes upon which the operations 200 are to be performed. If there is another influencing attribute, at block 216 the operations 200 may include returning to block 206, to select a pair of attributes including the target attribute and a next one of the influencing attributes. If there are no more influencing attributes, at block 216 the operations 200 may include proceeding to block 218. To determine whether there is another influencing attribute, the system 100 may reference the list of influencing attributes determined at block 202.

At block 218, the operations 200 may include ranking influencing attributes based on correlation values respectively representing the correlation between each of the influencing attributes and the target attribute. The system 100 may use the attribute ranker 120 of the correlation management system 102 to rank the influencing attributes. The influencing attributes may be provided in a ranked list representing an influence of each of the influencing attributes on the target attribute. The system 100 may rank the influencing attributes by sorting the influencing attributes based on their respective correlation values in descending. In at least one example, the system 100 may normalize the correlation values to provide a normalized basis for ranking the influencing attributes. The system 100 may determine that an influencing attribute that has a higher ranking is more influential on the target attribute relative to an influencing attribute that has a lower ranking.

In at least one example, the system 100 may generate a weighted ranking. The weighted ranking may reflect different weights or significance levels associated with respective influencing attributes. For example, a ranking of one or more influencing attributes may be increased or decreased from an initial ranking based on the correlation value. The weighted ranking may include factors such as importance, urgency, frequency, complexity, cost, as well as combinations of these. The weighted ranking criteria may be determined from a user input, and/or the system 100 may automatically determine weighted ranking criteria. By way of example, the system 100 or a user input may give an increased weight to influencing attributes associated with high-performance target attributes or assets. Additionally, or in the alternative, the system 100 or a user input may give an increased weight to influencing attributes associated with urgent or mission-critical target attributes, such as those that are directly related to operability. For example, an influencing attribute that may influence a target attribute in a way that may result in a total system failure may be given an increased weight even if the correlation value suggests a relatively low degree of correlation. As another example, an influencing attribute that may influence a target attribute in an insignificant way may be given a decreased weight even if the correlation value suggests a relatively high degree of correlation. Additionally, or in the alternative, the system 100 or a user input may give an increased weight to influencing attributes associated with items that are more complex or that require more resources to maintain or repair. Additionally, or in the alternative, the system 100 or a user input may give an increased weight to influencing attributes associated with items that have a higher cost or a higher risk factor.

As shown in FIG. 2B, the operations 200 may include, at block 220, selecting one or more influencing attributes for configuration based on the ranking. The system 100 may use the attribute ranker 120 of the correlation management system 102 to select influencing attributes for configuration based on the ranking. The system 100 may select influencing attributes for configuration based on a list that represents the ranking provided at block 218. Additionally, or in the alternative, the system 100 may select one or more influencing attributes for configuration based on a user input. For example, the user input may supplement, augment, or override the ranking provided at block 218.

At block 222, the operations 200 may include determining values for the selected influencing attributes that correspond to a preferred range of values for the target attribute. The system 100 may use the range selector 124 of the attribute ranker 120 to determine values for the selected influencing attributes. In at least one example, the system 100 may perform historical data analysis to determine values for the selected influencing attributes. For example, the system 100 may utilize a historical data table in the data repository 104. The system 100 may determine the values for the selected influencing attributes based on a temporal association with the preferred range of values for the target attribute. For example, the system 100 may select values for the influencing attributes corresponding to a time period when current values for the target attribute matched the preferred range of values for the target attribute. Additionally, or in the alternative, the system 100 may utilize simulation to determine values for the selected influencing attributes. For example, by using simulation, the system 100 may determine values for the selected influencing attributes even if the available data does not directly or fully overlap with a time period when current values for the target attribute matched the preferred range of values for the target attribute.

At block 224, the operations 200 may include configuring the determined values for the selected influencing attributes as the preferred values for the selected influencing attributes. The system 100 may use the range selector 124 of the attribute ranker 120 to configure the determined values for the selected influencing attributes as the preferred values. In at least one example, the system 100 may generate an array that identifies determined values for the selected influencing attributes and the preferred values for the selected influencing attributes. The system 100 may map the determined values to the preferred values in the array. In at least one example, the system may modify the configuration based on a user input.

### 5. Correlation-Based Asset Management

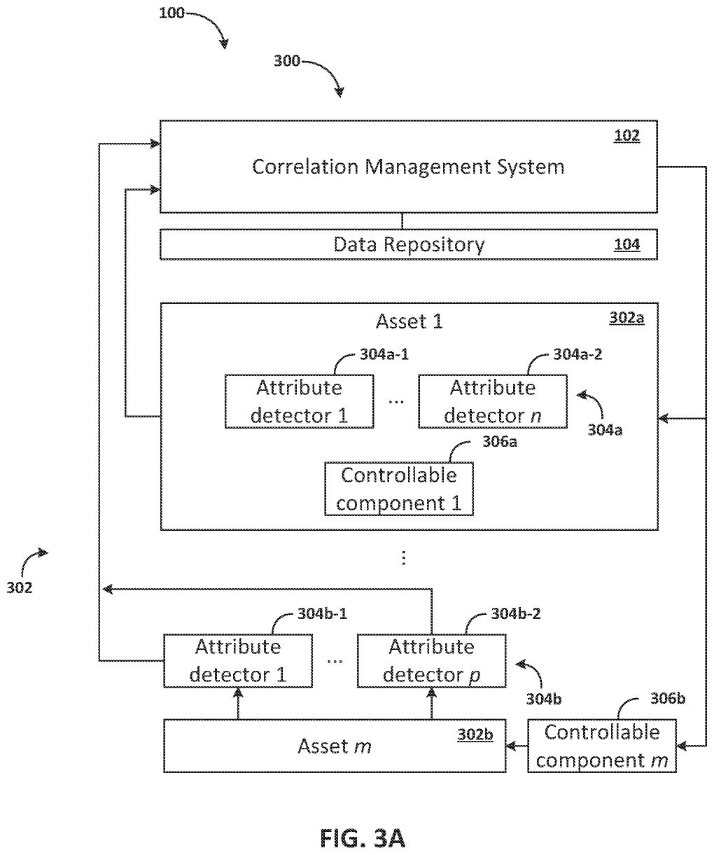

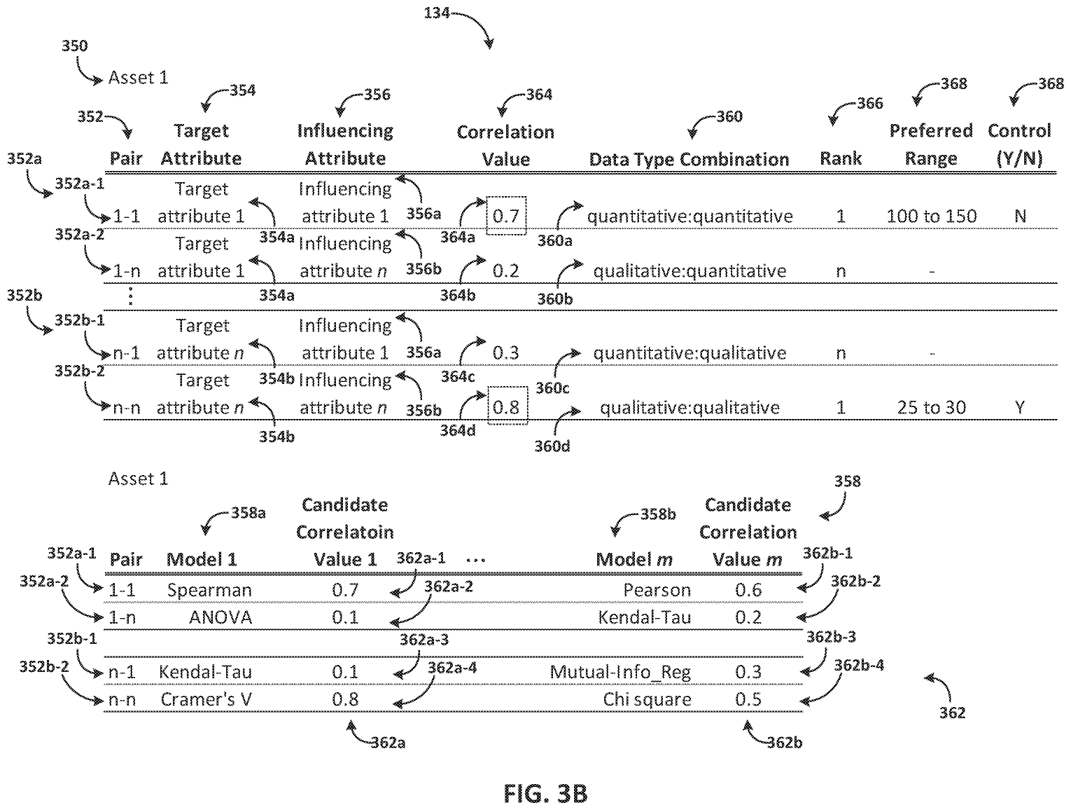

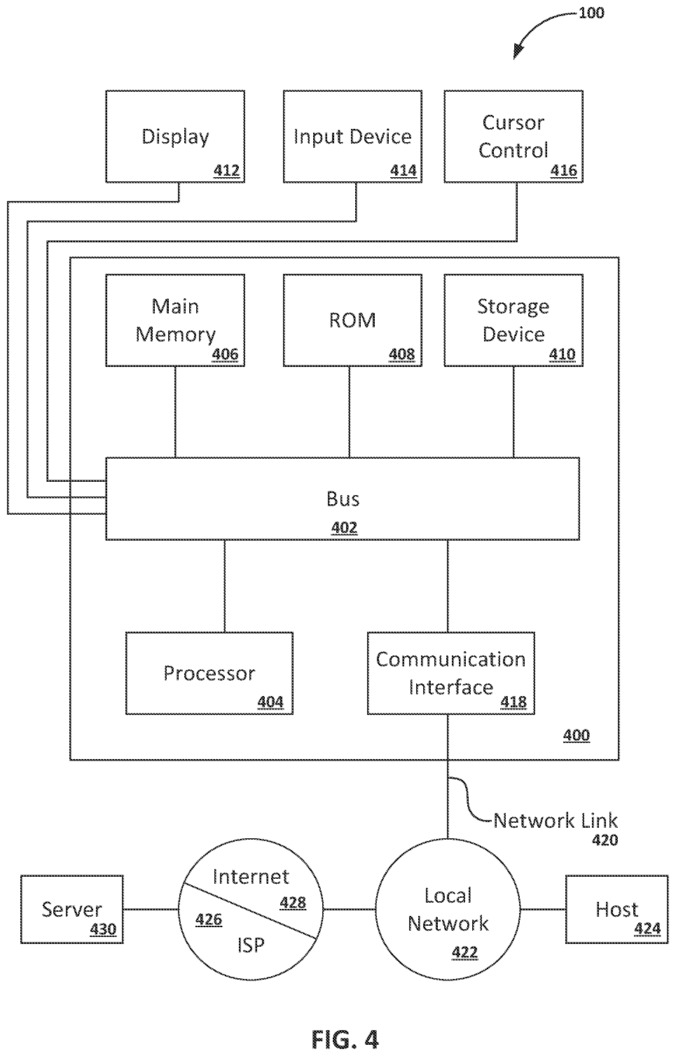

Referring now to FIGS. 3A and 3B, example systems and operations are further described. As shown in FIG. 3A, a system 100 may include an asset management system 300. The asset management system 300 may include a set of m number of assets 302 associated with the system 100. For example, the set of assets 302 may include a first asset 302a and a second asset 302b. A set of n number of attribute detectors 304 may be associated with a particular asset 302. For example, the first set of assets 302a may include a first set of attribute detectors 304a, including a first attribute detector 304a-1 and a second attribute detector 304a-2. Additionally, or in the alternative, the second set of assets 302b may include a second set of attribute detectors 304b, including a third attribute detector 304b-1 and a fourth attribute detector 304b-2. The attribute detectors may include sensors, controllers, and/or computing devices associated with a respective asset 302. As shown with respect to the first asset 302a, one or more attribute detectors 304 may define a portion of the asset 302. Additionally, or in the alternative, as shown with respect to the second asset 302b, one or more attribute detectors may be operably coupled to the asset 302.

The assets 302 and/or the attribute detectors 304 may be communicatively coupled or couplable to the correlation management system 102 and/or the data repository 104. The attribute detectors 304 may provide inputs, such as sensor readings, corresponding to attributes of the asset 302 to the correlation management system 102. The correlation management system 102 may determine values for an attribute associated with an asset 302 based on the inputs from the attribute detector 304. The values may be utilized as or included in a dataset 134. The dataset 134 including the values corresponding to one or more attribute detectors 304 may be utilized by the correlation management system 102 to determine correlations between target attributes and influencing attributes. The attribute detectors 304 may correspond to influencing attributes and/or target attributes, for example, as may be determined by the correlation management system 102. Additionally, or in the alternative, the dataset 134 including the values corresponding to one or more attribute detectors 304 may be utilized by the correlation management system 102 to monitor whether respective influencing attributes are within a preferred range of values.

In one example, one or more controllable components 306 may be associated with an asset 302. For example, a first controllable component 306a may be associated with the first asset 302a, and a second controllable component 306b may be associated with the second asset 302b. As shown with respect to the first asset 302a, a controllable component 306 may define a portion of the asset 302. Additionally, or in the alternative, as shown with respect to the second asset 302b, a controllable component 306 may be operably coupled to the asset 302. The controllable components 306 may receive control commands from the correlation management system 102, for example, responsive to a current value for a respective influencing attribute, for example, to maintain the respective influencing attribute within a preferred range of values.

Referring to FIG. 3B, example datasets 134 are further described. A dataset 134 may include data values associated with one or more assets 302. For example, as shown, the dataset 134 may include first data 350, associated with the first asset 302a. As shown, a dataset 134 may include a set of attribute pairs 352 that respectively include a target attribute 354 and an influencing attribute 356. The set of attribute pairs 352 may include n pairs of the same target attribute 354 and one of a set of n influencing attributes 356 whose influence on the target attribute is to be determined. For example, a first set of attribute pairs 352a associated with a first target attribute 354a may include a pairing of the first target attribute 354a with one or more influencing attributes 356, such as a pairing of a pairing of the first target attribute 354a with a first influencing attribute 356a, and a pairing of the first target attribute 354a with a second influencing attribute 356b. A second set of attribute pairs 352b associated with a second target attribute 354b may include a pairing of the second target attribute 354b with one or more influencing attributes 356, such as a pairing of the second target attribute 354b with the first influencing attribute 356a, and a pairing of the second target attribute 354b with the second influencing attribute 356b.

For each attribute pair 352, the system 100 may selects one or more correlation models 358, for determining a correlation between that pair of attributes. The correlation models 358 may be selected based on a data-type combination 360 for the attribute pair 352. For example, the system 100 may select a first correlation model 358a and a second correlation model 358b for the respective attribute pairs 352. As shown, the first set of attribute pairs 352a may include a first attribute pair 352a-1 representing a first data-type combination 360a, and a second attribute pair 352a-2 representing a second data-type combination 360b. The first data-type combination 360a may be quantitative:quantitative. Based on the first data-type combination 360a, the first correlation model 358a for the first attribute pair 352a-1 may be Spearman, and the second correlation model 358b for the first attribute pair 352a-1 may be Pearson. The second data-type combination 360b may be qualitative:quantitative. Based on the second data-type combination 360b, the first correlation model 358a for the second attribute pair 352a-2 may be ANOVA, and the second correlation model 358b for the second attribute pair 352a-2 may be Kendal-Tau.

As further shown in FIG. 3B, the second set of attribute pairs 352b may include a third attribute pair 352b-1 representing a third data-type combination 360c, and a fourth attribute pair 352b-2 representing a fourth data-type combination 360d. The third data-type combination 360c may be quantitative:qualitative. Based on the third data-type combination 360c, the first correlation model 358a for the third attribute pair 352b-1 may be Kendall tau, and the second correlation model 358b for the third attribute pair 352b-1 may be Mutual_info_regression. The fourth data-type combination 360d may be qualitative: qualitative. Based on the fourth data-type combination 360d, the first correlation model 358a for the fourth attribute pair 352b-2 may be Cramer's V Test, and the second correlation model 358b for the fourth attribute pair 352b-2 may be Chi-Square.

Referring still to FIG. 3B, the system 100 may compute candidate correlation values 362 for the respective attribute pair 352 using the respective correlation models 358. The candidate correlation values 362 represent the correlation between the target attribute 354 and the influencing attribute 356 for the respective attribute pair 352. For respective attribute pairs 352, the system 100 may calculate a first candidate correlation value 362a using the first correlation model 358a, and a second correlation value 362b using the second correlation model 358b.

In one example, for the first attribute pair 352a-1, the system 100 may calculate a first instance 362a-1 of the first candidate correlation value 362a using the first correlation model 358a, and a first instance 362b-1 of the second candidate correlation value 362b using the second correlation model 358b. For the second attribute pair 352a-2, the system 100 may calculate a second instance 362a-2 of the first candidate correlation value 362a using the first correlation model 358a, and a second instance 362b-2 of the second candidate correlation value 362b using the second correlation model 358b.

In one example, for the third attribute pair 352b-1, the system 100 may calculate a third instance 362a-3 of the first candidate correlation value 362a using the first correlation model 358a, and a third instance 362b-3 of the second candidate correlation value 362b using the second correlation model 358b. For the fourth attribute pair 352b-2, the system 100 may calculate a fourth instance 362a-4 of the first candidate correlation value 362a using the first correlation model 358a, and a fourth instance 362b-4 of the second candidate correlation value 362b using the second correlation model 358b.

Referring further to FIG. 3B, the system 100 may determine a correlation value 364 for the respective sets of attribute pairs 352. The correlation values 364 may be selected from the candidate correlation values 358. In one example, the correlation value 364 selected for a particular attribute pair 352 may be the candidate correlation value 358 representing the highest correlation from among the candidate correlation values 358 for the attribute pair 352. As shown, the correlation values 364 may include a first correlation value 364a corresponding to the first attribute pair 352a-1. For the first attribute pair 352a-1, the first instance 362a-1 of the first candidate correlation value 362a may be selected as the first correlation value 364a, for example, as having the highest correlation from among the candidate correlation values 362 corresponding to the first attribute pair 352a-1. For example, as shown in FIG. 3B, the first instance 362a-1 of the first candidate correlation value 362a has a higher correlation than the second instance 362b-2 of the second candidate correlation value 362b.

In one example, the correlation values 364 may additionally or alternatively include a second correlation value 364b corresponding to the second attribute pair 352a-2. For the second attribute pair 352a-2, the second instance 362b-2 of the second candidate correlation value 362b may be selected as the second correlation value 364b, for example, as having the highest correlation from among the candidate correlation values 362 corresponding to the second attribute pair 352a-2. For example, as shown in FIG. 3B, the second instance 362b-2 of the second candidate correlation value 362b has a higher correlation than the second instance 362a-2 of the first candidate correlation value 362a.

In one example, the correlation values 364 may additionally or alternatively include a third correlation value 364c corresponding to the third attribute pair 352b-1. For the third attribute pair 352b-1, the third instance 362b-3 of the second candidate correlation value 362b may be selected as the third correlation value 364c, for example, as having the highest correlation from among the candidate correlation values 362 corresponding to the third attribute pair 352b-1. For example, as shown in FIG. 3B, the third instance 362b-3 of the second candidate correlation value 362b has a higher correlation than the third instance 362a-3 of the first candidate correlation value 362a.

In one example, the correlation values 364 may additionally or alternatively include a fourth correlation value 364d corresponding to the fourth attribute pair 352b-2. For the fourth attribute pair 352b-2, the fourth instance 362a-4 of the first candidate correlation value 362a may be selected as the fourth correlation value 364d, for example, as having the highest correlation from among the candidate correlation values 362 corresponding to the fourth attribute pair 352b-2. For example, as shown in FIG. 3B, the fourth instance 362a-4 of the first candidate correlation value 362a has a higher correlation than the fourth instance 362b-4 of the second candidate correlation value 362b.

In one example, the system 100 may determine a ranking 366 the correlation values 364 for the respective sets of attribute pairs 352. As shown in FIG. 3B, for the first set of attribute pairs 352a, the first correlation value 364a has a ranking 366a that is higher than that of the second correlation value 364b. Additionally, or in the alternative, for the second set of attribute pairs 352b, the fourth correlation value 364d may have a ranking 366b that is higher than that of the third correlation value 364c.

In one example, the system 100 may determine a preferred range 368 for one or more of the influencing attributes 356. In one example, the preferred range 368 may be determined for influencing attributes that have a correlation value that meets a correlation threshold. By way of example, FIG. 3B shows the first correlation value 364a and the fourth correlation value 364d surrounded by a dashed box, indicating that those correlation values meet the correlation threshold. As shown, the system 100 provides a preferred range 368 for the first correlation value 364a and the fourth correlation value 364d.

In one example, the system 100 may dispatch control commands to one or more controllable components 306 responsive to a current value for a respective influencing attribute 356, for example, to maintain the respective influencing attribute 356 within the preferred range 368. As shown in FIG. 3B, by way of example, the first influencing attribute 356a is designated as non-controlled with respect to the first target attribute 354a, and the second influencing attribute 356b is designated as controlled with respect to the second target attribute 354b.

### 6. Practical Applications, Advantages & Improvements

Advantageously, asset performance may be improved by determining how respective attributes influence performance of the asset in accordance with the present disclosure. For example, by selecting a set of correlation models based on a data-type or data-type combination for the respective influencing attribute and the target attribute, a suitable set of correlation models can be utilized, and appropriate correlation values may be obtained, regardless of the particular data-type or data-type combination. Additionally, by selecting a correlation value to represent a correlation between the influencing attribute and the target attribute based on a degree of observational error in the respective correlation, a particularly suitable correlation model and resulting correlation value may be utilized for each of the respective influencing attributes when determining how the respective attributes influence performance of the asset. As a result, bias may be reduced and/or accuracy may be improved. For example, even among common data-types or common data-type combinations, various suitable correlation models may produce correlations with varying degrees of observational error depending on the particular influencing attribute and the target attribute being correlated. Accordingly, the present disclosure provides for a particularly suitable correlation model for each respective correlation evaluation between an influencing attribute and a target attribute. Further, by normalizing the correlation values, correlations derived from respectively different correlation models may be compared to one another on a normalized basis. As a result, the extent to which respective influencing attributes influence a target attribute may be determined and/or ranked based on correlations performed using respectively different correlation models, for example, even if the respective correlation models would provide nominally incomparable correlation values.

The ranking of the respective influencing attributes based on the extent to which they influence a target attribute may allow user to focus their efforts on the attributes that are most impactful, for example, when seeking to improve the operational performance of an asset. For example, the ranking may allow users to focus on the particular influencing attributes that have a notable impactful on a target attribute, and/or on the particular target attributes that have a notable impact on the operational performance of the asset. Additionally, or in the alternative, the ranking may uncover influences that may have otherwise gone unnoticed or unappreciated.

The preferred range of values for a respective influencing attribute may be utilized advantageously to improve a variety of practical applications including, but not limited to asset performance, including, by way of example, reducing cost, increasing quality, increasing productivity, expediting response times, automating quality inspections, streamlining production planning, controlling manufacturing processes, managing supply chains, preventing fraud, and so forth. By way of example, influencing attributes may be adjusted and/or set to within the respective preferred value range to realize these and other performance improvement. Additionally, or in the alternative, the triggering of notifications may be utilized to enable rapid response to instances when an influencing attribute may depart from a preferred range of values. Additionally, or in the alternative, by controlling respective system components, departures from the preferred range of values for the respective influencing attributes may be minimized.

In one example, the systems and methods disclosed herein may be utilized in the field of predictive maintenance. For example, correlation analysis may be performed for in-service equipment in order to estimate when maintenance should be performed on an asset, or when an asset may have an increased likelihood of malfunctioning. In order to identify which factors are most correlated with asset performance, data on various attributes may be collected from attribute detectors can be collected over time (e.g., such as sensor readings for temperature, vibration, pressure, etc.). By analyzing the correlation between the data from the attribute detectors (e.g., sensor readings) and asset performance, engineers can identify which attributes are most predictive of asset performance. For example, a probable failure date or a probably quality drop-off may be predicted. A correlation model may provide a prompt based on the correlation analysis to initiate maintenance operations or other proactive actions responsive to the correlation analysis. As a result, unplanned downtime can be avoided and/or asset performance can be improved.

As a further example, predictive maintenance may be performed using the presently disclosed systems and methods in the context of a fleet management system, including for vehicles such as for automobiles, railway vehicles, rolling stock, aircraft, marine vessels, construction machinery, mining machinery, or the like. Additionally, or in the alternative, such assets may include equipment and auxiliary systems, such as those associated with such vehicles, including engines, motors, lubrication systems, cooling systems, or the like. As another predictive maintenance may be performed using the presently disclosed systems and methods in the context of oil and gas systems, such as offshore or deep-water systems.

As another example, the presently disclosed systems and methods may be utilized to monitor or control manufacturing processes or equipment. For example, correlation analysis may identify relationships between different production factors, such as machine settings, raw materials, production rate, or product quality. This information can be used to improve production processes, to improve product quality, or to reduce defects.

In one example, the presently disclosed systems and methods may be utilized in the context of supply chain management. Correlation analysis can be performed to identify the degree of association between different factors that affect the performance of the supply chain. For example, correlation models may be generated that determine the relationship between the demand for a product and allocation of supply chain resources to the product. These supply chain resources may include: inventory to be stocked, raw materials or components to be procured, manufacturing resources to be allocated, transportation resources to be allocated, or the like. By analyzing correlations between various supply chain parameters, allocation of supply chain resources can be improved, supply chain costs can be reduced, or performance metrics can be improved. Example improvements may include reduced cost, improved response times, streamlined demand/production planning, or the like. Additionally, or in the alternative, correlation models may be generated that determine relationships between supply chain timing parameters, such as lead times and delivery times. Correlation models can be used to improve performance metrics such as delivery times, and/or to provide on-demand or just-in-time supply chain systems. Additionally, or in the alternative, correlation models can be used to determine trade-offs such as between costs and delivery times, and/or to determine transportation routes and/or modes of transportation that meet supply chain performance objectives. Further uses of the presently disclosed systems and methods include performance of automated quality inspections, warehouse management, fraud prevention, or the like.

In one example, the presently disclosed systems and methods may be utilized in the context of internet-of-things (IoT) systems and devices. Correlation analysis may be used to identify patterns and relationships between data sets associated with various IoT devices. For example, IoT devices may include sensors that measure different parameters. Relationships between device performance, user behavior, or environmental conditions can be identified through correlation analysis and correlation models can be generated that provide improved performance parameters under various conditions.

In another example, the systems and methods disclosed herein may be utilized to analyze the performance of computer systems based on the behavior of various system components. For instance, if a server network often experiences slow processing and delayed transactions, correlation analysis can be used to identify possible relationships between the server's CPU usage, memory usage, and network traffic. By identifying which factors are correlated with performance issues, the system administrator can then prioritize improvements to the system based on the factors revealed by the correlation analysis as influencing the slow processing, and ultimately improve the system's overall performance.

As a further example, the presently disclosed systems and methods may be utilized for predictive maintenance or improvements for blockchain systems. For example, correlation analysis can be used to identify patterns in transaction data, such as the most common transaction types, transaction volumes, and timeframes. This information can be used to optimize transaction processing times and reduce transaction costs. For example, by identifying the most common transaction types, developers can optimize the blockchain system to handle those transactions more efficiently, reducing processing times and increasing throughput. Additionally, or in the alternative, correlations can be identified in sensor data from blockchain systems, such as network activity, temperature, and power consumption. This information can be used to route blockchain transactions to more efficient nodes in the blockchain and/or to predict potential issues before they occur and perform maintenance proactively, increasing productivity, reducing downtime, and increasing system reliability.

In one example, the presently disclosed systems and methods may be utilized to identify relationships between different financial assets and market conditions. For example, a target attribute may include a security (e.g., stocks, bonds, options, mutual funds, exchange-traded funds, futures, derivatives, commodities, etc.), and an influencing attribute may include an attribute associated with a market condition, or another security. A correlation model may be used to predict changes in price or valuation of different securities, and portfolios can be constructed and/or transactions can be initiated that meet desired characteristics, such as rate of return, risk, volatility, liquidity, diversification, timing, or the like.

In one example, the presently disclosed systems and methods may be utilized in the field of healthcare, social sciences, or environmental sciences. In the field of healthcare, correlation analysis can be used to identify relationships between different health factors, such as diet, exercise, vital signs, medical diagnosis, or risk. A target attribute may include a desired health factor, and influencing attributes may include one or more health, social, or environmental factors. This information can be used to develop personalized treatment plans and improve patient outcomes. In the field of social sciences, correlation analysis can be used to identify relationships between different social factors, such as education, income, demographics, attitudes, behaviors, choices, health and wellness, crime rates, or the like. This information can be used to develop policies to address social issues and improve quality of life. For example, a target attribute may include a desired social condition, and correlations between the desired social condition and various influencing attributes may be analyzed to develop correlation model that can be used to improve social conditions. In the field of environmental sciences, correlation analysis can be used to identify relationships between different environmental factors, such as air quality, water quality, or weather patterns. The correlation analysis may additionally or alternatively consider environmentally impactful activities, such as discharges of pollutants to air and/or water. This information can be used to predict environmental impacts and initiate mitigation practices. For example, a target attribute may include a desired environmental condition, and correlations between the desired environmental condition and various influencing attributes may be analyzed to develop correlation model that can be used to improve environmental conditions. Additionally, or in the alternative, the correlation models may be developed that address interrelated correlations between health, social, or environmental factors.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 3 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary data or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416. such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Computer Networks and Cloud Networks

In one or more embodiments, the PR system is connected to, or distributed across, a computer network. The computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause a performance of operations comprising:
identifying a target attribute and a plurality of influencing attributes;
determining a first correlation value representing a first correlation between the target attribute and a first influencing attribute of the plurality of influencing attributes at least by:
identifying a particular set of values for the target attribute;
determining a particular data-type corresponding to the particular set of values for the target attribute;
identifying a first set of values for the first influencing attribute of the plurality of influencing attributes;
determining a first data-type corresponding to the first set of values;
determining a first data-type combination for the target attribute and the first influencing attribute, the first data-type combination comprising the particular data-type and the first data-type;
selecting a first set of one or more correlation models based on the first data-type combination for the target attribute and the first influencing attribute;
executing the selected first set of one or more correlation models to compute a first set of one or more correlation values;
selecting the first correlation value from the first set of one or more correlation values to represent the first correlation between the target attribute and the first influencing attribute;
determining a second correlation value representing a second correlation between the target attribute and a second influencing attribute of the plurality of attributes at least by:
identifying a second set of values for the second influencing attribute of the plurality of influencing attributes;
determining a second data-type corresponding to the second set of values;
determining a second data-type combination for the target attribute and the second influencing attribute, the second data-type combination comprising the particular data-type and the second data-type, wherein the second data-type combination is different than the first data-type combination;
selecting a second set of one or more correlation models based on the second data-type combination for the target attribute and the second influencing attribute, wherein the second set of one or more correlation models is different than the first set of one or more correlation models;
executing the selected second set of one or more correlation models to compute a second set of one or more correlation values;
selecting the second correlation value from the second set of one or more correlation values to represent the second correlation between the target attribute and the second influencing attribute;
based on the first correlation value and the second correlation value, ranking the first influencing attribute higher than the second influencing attribute in a ranked list of the plurality of influencing attributes representing an influence of each of the plurality of influencing attributes on the target attribute.

2. The media of claim 1, wherein the first data-type combination is one of:
a quantitative data-type and a qualitative data-type;
a quantitative data-type and a quantitative data-type; and
a qualitative data-type and a qualitative data-type.

3. The media of claim 1,
wherein selecting the first set of one or more correlation models comprises selecting a first correlation model and a second correlation model;
executing the first correlation model to compute a first candidate correlation value to represent the first correlation between the target attribute and the first influencing attribute;
executing the second correlation model to compute a second candidate correlation value to represent the same first correlation between the target attribute and the first influencing attribute;
normalizing the first candidate correlation value and the second candidate correlation value to obtain a first normalized candidate correlation value and the second candidate correlation value;
selecting a higher one of the first normalized candidate correlation value and the second candidate correlation value as the first correlation value to represent the first correlation between the target attribute and the first influencing attribute.

4. The media of claim 1, wherein ranking the first influencing attribute higher than the second influencing attribute comprises:
normalizing the first correlation value and the second correlation value to respectively generate a first normalized correlation value and a second normalized correlation value;
determining that the first normalized correlation value is higher than the second normalized correlation value;
determining that the first influencing attribute is more influential on the target attribute than the second influencing attribute based on determining that the first normalized correlation value is higher than the second normalized correlation value.

5. The media of claim 1, wherein the operations further comprise:
based on the ranked list of the plurality of influencing attributes, determining a preferred range of values for the first influencing attribute without determining a preferred range of values for the second influencing attribute.

6. The media of claim 5, wherein determining the preferred range of values for the first influencing attribute comprises:
determining a preferred range of values for the target attribute;
determining a first range of values for the first influencing attribute that are mapped to the preferred range of values for the target attribute;
selecting the first range of values for the first influencing attribute as the preferred range of values for the first influencing attribute.

7. The media of claim 5, wherein the operations further comprise configuring a notification to be triggered when a current value for the first influencing attribute does not match the preferred range of values for the first influencing attribute.

8. The media of claim 5, wherein the operations further comprise configuring one or more system components to maintain the first influencing attribute within the preferred range of values for the first influencing attribute.

9. The media of claim 1, wherein the first data-type combination comprises a first quantitative data-type and a second quantitative data-type, and wherein the first set of correlation model comprises at least one of: a Pearson correlation model, a Spearman correlation model, or a mutual_info_regression correlation model.

10. The media of claim 1, wherein the first data-type combination comprises a quantitative data-type and a qualitative data-type, and wherein the first set of correlation model comprises at least one of: a Kendall tau correlation model, an ANOVA correlation model, a T-Test correlation model, or a mutual_info_classification correlation model.

11. The media of claim 1, wherein the first data-type combination comprises a first qualitative data-type and a second qualitative data-type, and wherein the first set of correlation models comprises at least one of: a Chi-Square correlation model, a Cramer's V Test correlation model, or a mutual_info_classification correlation model.

12. A method, comprising:
identifying a target attribute and a plurality of influencing attributes;
determining a first correlation value representing a first correlation between the target attribute and a first influencing attribute of the plurality of influencing attributes at least by:
identifying a particular set of values for the target attribute;
determining a particular data-type corresponding to the particular set of values for the target attribute;
identifying a first set of values for the first influencing attribute of the plurality of influencing attributes;
determining a first data-type corresponding to the first set of values;
determining a first data-type combination for the target attribute and the first influencing attribute, the first data-type combination comprising the particular data-type and the first data-type;
selecting a first set of one or more correlation models based on the first data-type combination for the target attribute and the first influencing attribute;
executing the selected first set of one or more correlation models to compute a first set of one or more correlation values;
selecting the first correlation value from the first set of one or more correlation values to represent the first correlation between the target attribute and the first influencing attribute;
determining a second correlation value representing a second correlation between the target attribute and a second influencing attribute of the plurality of attributes at least by:
identifying a second set of values for the second influencing attribute of the plurality of influencing attributes;
determining a second data-type corresponding to the second set of values;
determining a second data-type combination for the target attribute and the second influencing attribute, the second data-type combination comprising the particular data-type and the second data-type, wherein the second data-type combination is different than the first data-type combination;
selecting a second set of one or more correlation models based on the second data-type combination for the target attribute and the second influencing attribute, wherein the second set of one or more correlation models is different than the first set of one or more correlation models;
executing the selected second set of one or more correlation models to compute a second set of one or more correlation values;
selecting the second correlation value from the second set of one or more correlation values to represent the second correlation between the target attribute and the second influencing attribute;
based on the first correlation value and the second correlation value, ranking the first influencing attribute higher than the second influencing attribute in a ranked list of the plurality of influencing attributes representing an influence of each of the plurality of influencing attributes on the target attribute;
wherein the method is performed by at least one device including a hardware processor.

13. The method of claim 12, wherein the first data-type combination is one of:
a quantitative data-type and a qualitative data-type;
a quantitative data-type and a quantitative data-type; and
a qualitative data-type and a qualitative data-type.

14. The method of claim 12,
wherein selecting the first set of one or more correlation models comprises selecting a first correlation model and a second correlation model;
executing the first correlation model to compute a first candidate correlation value to represent the first correlation between the target attribute and the first influencing attribute;
executing the second correlation model to compute a second candidate correlation value to represent the same first correlation between the target attribute and the first influencing attribute;
normalizing the first candidate correlation value and the second candidate correlation value to obtain a first normalized candidate correlation value and the second candidate correlation value;
selecting a higher one of the first normalized candidate correlation value and the second candidate correlation value as the first correlation value to represent the first correlation between the target attribute and the first influencing attribute.

15. The method of claim 12, wherein ranking the first influencing attribute higher than the second influencing attribute comprises:
normalizing the first correlation value and the second correlation value to respectively generate a first normalized correlation value and a second normalized correlation value;
determining that the first normalized correlation value is higher than the second normalized correlation value;
determining that the first influencing attribute is more influential on the target attribute than the second influencing attribute based on determining that the first normalized correlation value is higher than the second normalized correlation value.

16. The method of claim 12, wherein the operations further comprise:
based on the ranked list of the plurality of influencing attributes, determining a preferred range of values for the first influencing attribute without determining a preferred range of values for the second influencing attribute.

17. The method of claim 16, wherein determining the preferred range of values for the first influencing attribute comprises:
determining a preferred range of values for the target attribute;
determining a first range of values for the first influencing attribute that are mapped to the preferred range of values for the target attribute;
selecting the first range of values for the first influencing attribute as the preferred range of values for the first influencing attribute.

18. The method of claim 16, wherein the operations further comprise configuring a notification to be triggered when a current value for the first influencing attribute does not match the preferred range of values for the first influencing attribute.

19. The method of claim 16, wherein the operations further comprise configuring one or more system components to maintain the first influencing attribute within the preferred range of values for the first influencing attribute.

20. The method of claim 12, wherein the first data-type combination comprises a first quantitative data-type and a second quantitative data-type, and wherein the first set of correlation model comprises at least one of: a Pearson correlation model, a Spearman correlation model, or a mutual_info_regression correlation model.

21. The method of claim 12, wherein the first data-type combination comprises a quantitative data-type and a qualitative data-type, and wherein the first set of correlation model comprises at least one of: a Kendall tau correlation model, an ANOVA correlation model, a T-Test correlation model, or a mutual_info_classification correlation model.

22. The method of claim 12, wherein the first data-type combination comprises a first qualitative data-type and a second qualitative data-type, and wherein the first set of correlation models comprises at least one of: a Chi-Square correlation model, a Cramer's V Test correlation model, or a mutual_info_classification correlation model.

23. A system comprising:
at least one hardware processor;
the system being configured to execute operations, using the at least one hardware processor, the operations comprising:
identifying a target attribute and a plurality of influencing attributes;
determining a first correlation value representing a first correlation between the target attribute and a first influencing attribute of the plurality of influencing attributes at least by:
identifying a particular set of values for the target attribute;
determining a particular data-type corresponding to the particular set of values for the target attribute;
identifying a first set of values for the first influencing attribute of the plurality of influencing attributes;
determining a first data-type corresponding to the first set of values;
determining a first data-type combination for the target attribute and the first influencing attribute, the first data-type combination comprising the particular data-type and the first data-type;
selecting a first set of one or more correlation models based on the first data-type combination for the target attribute and the first influencing attribute;
executing the selected first set of one or more correlation models to compute a first set of one or more correlation values;
selecting the first correlation value from the first set of one or more correlation values to represent the first correlation between the target attribute and the first influencing attribute;
determining a second correlation value representing a second correlation between the target attribute and a second influencing attribute of the plurality of attributes at least by:
identifying a second set of values for the second influencing attribute of the plurality of influencing attributes;
determining a second data-type corresponding to the second set of values;
determining a second data-type combination for the target attribute and the second influencing attribute, the second data-type combination comprising the particular data-type and the second data-type, wherein the second data-type combination is different than the first data-type combination;
selecting a second set of one or more correlation models based on the second data-type combination for the target attribute and the second influencing attribute, wherein the second set of one or more correlation models is different than the first set of one or more correlation models;
executing the selected second set of one or more correlation models to compute a second set of one or more correlation values;
selecting the second correlation value from the second set of one or more correlation values to represent the second correlation between the target attribute and the second influencing attribute;
based on the first correlation value and the second correlation value, ranking the first influencing attribute higher than the second influencing attribute in a ranked list of the plurality of influencing attributes representing an influence of each of the plurality of influencing attributes on the target attribute.

24. The system of claim 23, wherein the first data-type combination is one of:
a quantitative data-type and a qualitative data-type;
a quantitative data-type and a quantitative data-type; and
a qualitative data-type and a qualitative data-type.

25. The system of claim 23,
wherein selecting the first set of one or more correlation models comprises selecting a first correlation model and a second correlation model;
executing the first correlation model to compute a first candidate correlation value to represent the first correlation between the target attribute and the first influencing attribute;
executing the second correlation model to compute a second candidate correlation value to represent the same first correlation between the target attribute and the first influencing attribute;
normalizing the first candidate correlation value and the second candidate correlation value to obtain a first normalized candidate correlation value and the second candidate correlation value;
selecting a higher one of the first normalized candidate correlation value and the second candidate correlation value as the first correlation value to represent the first correlation between the target attribute and the first influencing attribute.

26. The system of claim 23, wherein ranking the first influencing attribute higher than the second influencing attribute comprises:
normalizing the first correlation value and the second correlation value to respectively generate a first normalized correlation value and a second normalized correlation value;
determining that the first normalized correlation value is higher than the second normalized correlation value;
determining that the first influencing attribute is more influential on the target attribute than the second influencing attribute based on determining that the first normalized correlation value is higher than the second normalized correlation value.

27. The system of claim 23, wherein the operations further comprise:
based on the ranked list of the plurality of influencing attributes, determining a preferred range of values for the first influencing attribute without determining a preferred range of values for the second influencing attribute.

28. The system of claim 27, wherein determining the preferred range of values for the first influencing attribute comprises:
determining a preferred range of values for the target attribute;
determining a first range of values for the first influencing attribute that are mapped to the preferred range of values for the target attribute;
selecting the first range of values for the first influencing attribute as the preferred range of values for the first influencing attribute.

29. The system of claim 27, wherein the operations further comprise configuring a notification to be triggered when a current value for the first influencing attribute does not match the preferred range of values for the first influencing attribute.

30. The system of claim 27, wherein the operations further comprise configuring one or more system components to maintain the first influencing attribute within the preferred range of values for the first influencing attribute.

31. The system of claim 23, wherein the first data-type combination comprises a first quantitative data-type and a second quantitative data-type, and wherein the first set of correlation model comprises at least one of: a Pearson correlation model, a Spearman correlation model, or a mutual_info_regression correlation model.

32. The system of claim 23, wherein the first data-type combination comprises a quantitative data-type and a qualitative data-type, and wherein the first set of correlation model comprises at least one of: a Kendall tau correlation model, an ANOVA correlation model, a T-Test correlation model, or a mutual_info_classification correlation model.

33. The system of claim 23, wherein the first data-type combination comprises a first qualitative data-type and a second qualitative data-type, and wherein the first set of correlation models comprises at least one of: a Chi-Square correlation model, a Cramer's V Test correlation model, or a mutual_info_classification correlation model.
